(19) United States
(12) Patent Application Publication
(10) Pub. No.: US 2004/0038105 A1
(43) Pub. Date: Feb. 26, 2004

(54) Cation-conducting or proton-conducting ceramic membrane infiltrated with an ionic liquid, method for the production thereof and use of the same

(76) Inventors: Volker Hennige, Dulmen (DE); Christian Hying, Rhede (DE); Gerhard Horpel, Nottuln (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/433,488

(22) PCT Filed: Oct. 29, 2001
(86) PCT No.: PCT/EP01/12499

(30) Foreign Application Priority Data
Dec. 13, 2000 (DE) 10061959.2

(51) Int. Cl. H01M 8/10; C08J 5/22; H01M 10/40

(52) U.S. Cl. 429/33; 429/307; 429/316; 429/317; 521/27

(57) ABSTRACT

The invention relates to a cation- and/or proton-conducting membrane, to a process for producing it, and to its use.

The membrane of the invention represents a novel class of solid, proton-conducting membranes. It is based on a porous and flexible ceramic membrane described in PCT/EP98/05939. The latter is modified so that it has ion-conducting properties. This membrane is subsequently treated with an ionic liquid. As a result of the use of the ionic liquid, the membrane of the invention has very good proton/cation conductivity even at temperatures above 100° C. The proton/cation-conducting ceramic membrane remains flexible and may be used without problems as a membrane in a fuel cell.

The present invention relates to a cation- and/or proton-conducting membrane, to a process for producing it and to its use, especially in a fuel cell.

At the present time in the field of fuel cells for the automotive application sector, i.e., for fuel cell operating temperatures of below 200° C., the materials used comprise exclusively unfilled polymers or filled polymers (“composites”). The membranes used most frequently are those made from polymeric materials such as Nafion® (DuPont, fluorinated framework with a sulfonic acid functionality) and related systems. Another example of a purely organic, proton-conducting polymer comprises the sulfonated polyether ketones that are described, inter alia, by Hoechst in EP 0 574 791 B1. All of these polymers have the disadvantage that the proton conductivity decreases sharply as the air humidity falls (water acts as an H⁺ carrier. Accordingly, these membranes have to be swollen in water before their use in the fuel cell. At high temperatures, which are unavoidable in the reformate fuel cell or direct methanol fuel cell (DMFC), it is no longer possible, or possible only with restrictions, to use these systems, on account of the fact that the membrane may easily dry out, with the stated consequences for the proton conductivity.

A further problem of polymer membranes for use in a DMFC is their great permeability for methanol. Because of the crossover of methanol through the membrane onto the cathode side, the fuel cell frequently suffers severe performance detractions.

For all these reasons, the use of organic polymer membranes for the reformate fuel cell or DMFC is not ideal, and for any widespread use of fuel cells it is necessary to find new solutions.

Although inorganic proton conductors as well are known from the literature (see for example, “Proton Conductors”, P. Colomban, Cambridge University Press, 1992), the majority of them have conductivities which are too low (such as, for example, the zirconium phosphates or zirconium phosphonates, the heteropoly acids, and the grasslike systems and xerogels) or become technically useful in terms of conductivity only at high temperatures, typically at temperatures of more than 500° C., as is the case, for example, with the defect perovskites. Finally, another class of purely inorganic proton conductors, the family MHSO₄ where M is Cs, Rb or NH₄, although constituting good proton conductors, are at the same time readily soluble in water, so that they are ruled out of fuel cell applications on account of the fact that water is formed as a product on the cathode side and hence the membrane would be destroyed over time.

All systems which exhibit conductivities of technical interest at low temperatures of less than 200° C. have a conductivity which, like that of the polymer-based systems, depends heavily on the water partial pressure, and the systems are therefore of only limited usefulness at above 100° C.

It is an object of the present invention, therefore, to provide a cation/proton-conducting membrane which exhibits good conductivity for protons and cations and low permeability for methanol and for the other reaction gases (such as H₂, O₂).

It has surprisingly been found that ceramic, ion-conducting membranes which feature an ionic liquid have good proton and cation conductivities even at temperatures above 100° C. Moreover, such membranes exhibit little permeability for methanol and remain gastight even at high pressures.

The present invention accordingly provides a cation/proton-conducting membrane comprising a composite material based on at least one perforate and pervious support, where the voids of the membrane comprise an ionic liquid.

Moreover, the present invention provides a process for producing a membrane, where a composite material based on at least one perforate and pervious support, which comprises fully or partly infiltrating a membrane with an ionic liquid.

The present invention likewise provides for the use of a membrane as claimed in claim 1 as an electrolyte membrane in a fuel cell, as a catalyst for acid- or base-catalyzed reactions, and as a membrane in electrodialysis, in membrane electrolysis, or in electrolysis.

From WO 00/20115 and WO 00116902 ionic liquids (IL) have been known in the field of catalysis for some years. Ionic liquids are salt melts which preferably solidify only at temperatures below room temperature. A general overview on this topic can be found, for example, in Welton (Chem. Rev. 1999, 99, 2071). The salts involved are primarily imidazolium or pyridinium salts.

The literature also reports on the combination of proton-conducting polymer membranes (Nafion®) with ionic liquids (Doyle et al., J. Electrochem. Soc. 2000, 147, 34-37). This polymer membrane is a monolithic system and contains no composite material.

The proton/cation-conducting membranes of the invention have the advantage that they can be used at substantially higher temperatures than conventional proton-conducting membranes. This is so in particular by virtue of the fact that the ionic liquid (IL) takes over the role of the water as H⁺ carrier, i.e., it solvates the “naked” protons. Since the ionic liquids may have a substantially higher boiling point than water, the proton/cation-conducting membranes of the invention, containing ionic liquids, are particularly suitable for use as membranes in fuel cells which operate in accordance with the reformate or DMFC principle. By using the membranes of the invention it is possible to obtain fuel cells which are distinguished by high power densities at high temperatures in a water-free atmosphere.

WO 99/62620 was first to describe the production of an ion-conducting pervious composite material based on a ceramic, and its use. The steel weave described as the preferred support in WO 99/62620 is, however, completely inappropriate for the application of the composite material as a membrane in fuel cells, since when the fuel cell is operated there may very readily be short circuits between the electrodes. For use in a fuel cell, this composite material, moreover, would have to be highly impervious, in extreme cases absolutely impervious, to all substances except the desired protons and/or cations.

The proton- and/or cation-conducting membranes of the invention may be ceramic or grasslike membranes and are described by way of example below, though are not restricted to these embodiments.

A feature of the proton- and/or cation-conducting membrane of the invention is that on and inside the support of the composite material there is at least one inorganic component substantially comprising at least one compound of a metal, semimetal or mixed metal with at least one element from main groups 3 to 7.

As composite materials having ion-conducting properties it is possible to use those known from WO 99/62620. For the purposes of the present invention, the inside of the support means voids or pores within a support.

The perforate and pervious support may comprise interstices having a size of from 0.5 m to 500 μm. The interstices may be pores, meshes, holes or other voids. The support may comprise at least one material selected from glasses, ceramics, minerals, plastics, amorphous substances, natural products, composites, or at least one combination of said materials. The support which may comprise the aforementioned materials may have been modified by a chemical, thermal or mechanical treatment method or by a combination of these treatment methods. The composite material preferably comprises a support comprising at least one glass, ceramic, natural fiber or plastic. With very particular preference the composite material comprises at least one support comprising at least interwoven, interbonded, felted or ceramically bound fibers, or at least sintered or bonded shapes, spheres or particles. Pervious supports may also be those which are, or have been made, pervious by laser treatment or ion beam treatment.

It may be advantageous for the support to comprise a nonwoven or woven made from fibers of at least one material selected from ceramics, glasses, minerals, plastics, amorphous substances, composites and natural products or fibers of at least one combination of said materials, such as asbestos, glass fibers, rockwool fibers, polyamide fibers, coconut fibers, and coated fibers, for example. It is preferred to use supports comprising interwoven glass fibers. With very particular preference the composite material comprises a support comprising at least one woven made from glass, the woven preferably comprising 11-tex yarns having 5-50 warp and/or weft threads and preferably 20-28 warp and 28-36 weft threads. Very preferably, use is made of 5.5-tex yarns having 10-50 warp and/or weft threads and preferably 20-28 warp and 28-36 weft threads.

In accordance with the invention, however, the support may also comprise at least one granular, sintered glass or glass nonwoven having a pore size of from 0.1 μm to 500 μm, preferably from 3 to 60 μm.

The composite material preferably comprises at least one support of a glass comprising at least one compound from the group consisting of SiO₂, Al₂O₃, and MgO. Alternatively, the support may comprise at least one ceramic from the group consisting of Al₂O₃, ZrO₂, TiO₂, SiO₂, Si₃N₄, SiC, and BN.

The inorganic component present in the membrane of the invention, which is the component from which the composite material is constructed, may comprise at least one compound of at least one metal, semimetal or mixed metal with at least one element from main groups 3 to 7 of the periodic table, or at least one mixture of said compounds. The compounds of the metals, semimetals or mixed metals may comprise at least elements from the transition group elements and from main groups 3 to 5 or at least elements from the transition group elements or from main groups 3 to 5, these compounds having a particle size of from 0.001 to 25 μm.

The inorganic component preferably comprises at least one compound of an element from transition groups 3 to 8 or at least one element from main groups 3 to 5 with at least one of the elements Te, Se, S, O, Sb, As, P, N, Ge, Si, C, Ga, Al or B or at least one compound of an element from transition groups 3 to 8 and at least one element from main groups 3 to 5 with at least one of the elements Te, Se, S, O, Sb, As, P, N, Ge, Si, C, Ga, Al or B, or a mixture of said compounds. With particular preference the inorganic component comprises at least one compound of at least one of the elements Sc, Y, Ti, Zr, V, Nb, Cr, Mo, W, Mn, Fe, Co, B, Al, Ga, In, Tl, Si, Ge, Sn, Pb, Sb or Bi with at least one of the elements Te, Se, S, O, Sb, As, P, N, C, Si, Ge or Ga, such as, for example, TiO₂, Al₂O₃, SiO₂, ZrO₂, Y₂O₃, B₄C, SiC, Fe₃O₄, Si₃N₄, BN, SiP, nitrides, sulfates, phosphides, silicides, spinels or yttrium aluminum garnet, or one of these elements itself. The inorganic component may also comprise aluminosilicates, aluminum phosphates, zeolites or partially exchanged zeolites, such as, for example, ZSM-5, Na-ZSM-5 or Fe-ZSM-5, or amorphous microporous mixed oxides which may contain up to 20% of nonhydrolyzable organic compounds, such as vanadium oxide-silicon oxide glass or aluminum oxide-silicon oxide-methylsilicon sesquioxide glasses, or glasses in the system W—Si—Zr—P—Ti—O, for example.

Preferably, at least one inorganic component is present in a particle size fraction having a particle size of from 1 to 250 nm or having a particle size of from 260 to 10,000 nm.

It may be advantageous if the composite material has at least two particle size fractions of at least one inorganic component. It may also be advantageous if the composite material has at least two particle size fractions of at least two inorganic components. The particle size ratio may be from 1:1 to 1:10,000, preferably from 1:1 to 1:100. The proportion of the particle size fractions in the composite material may preferably be from 0.01:1 to 1:0.01.

A feature of the membrane of the invention is that it possesses ion-conducting properties and in particular is ion-conducting at a temperature of from −40° C. to 350° C., preferably from −10° C. to 200° C.

The composite material comprises at least one organic and/or inorganic material that has ion-conducting properties. This ion-conducting material may be present as an admixture in the composite material.

However, it may also be advantageous if the inner and/or outer surfaces of the particles present in the composite material have been coated with a coat of an organic and/or inorganic material. Coats of this kind have a thickness of from 0.0001 to 10 μm, preferably a thickness of from 0.001 to 0.5 μm. It is also possible for the composite material to consist in whole or in part of the aforementioned materials.

In one particular embodiment of the ion-conducting composite material of the invention at least one organic and/or inorganic material having ion-conducting properties is present in the interparticulate volumes of the composite material. The former material fills the interparticulate volume in part, preferably almost completely. In particular, at least one organic and/or inorganic material that has ion-conducting properties fills the interstices of the composite material.

It may be advantageous if the material having ion-conducting properties comprises sulfonic acids, phosphonic acids, carboxylic acids or salts thereof, individually or as a mixture. Preference is given to the sulfonic or phosphonic acids, silylsulfonic acids or silylphosphonic acids. These ionic groups may be organic compounds bonded chemically and/or physically to inorganic particles, such as Al₂O₃, SiO₂, ZrO₂ or TiO₂. Preferably, the ionic groups are attached via aryl and/or alkyl chains to the inner and/or outer surface of the particles present in the composite material. In one specific embodiment, the SO₃H-bearing trihydroxysilylsulfonic acid is incorporated by way of the hydrolyzed precusor form of SiO₂ into the inorganic network.

The ion-conducting material of the composite material may also be an organic, ion-conducting material, such as a polymer, for example. With particular preference this polymer comprises a sulfonated polytetrafluoro-ethylene, a sulfonated polyvinylidene fluoride, an aminolyzed polytetrafluoroethylene, an aminolyzed polyvinylidene fluoride, a sulfonated polysulfone, an aminolyzed polysulfone, a sulfonated polyether imide, an aminolyzed polyether imide, a sulfonated polyether ketone or polyether ether ketone, an aminolyzed polyether ketone or polyether ether ketone, or a mixture of said polymers.

As inorganic, ion-conducting materials, the composite material may comprise at least one compound selected from the group consisting of oxides, oxyacids, phosphates, phosphides, phosphonates, sulfates, sulfonates, hydroxysilyl acids, sulfoarylphosphonates, vanadates, stannates, plumbates, chromates, tungstates, molybdates, manganates, titanates, silicates, aluminosilicates, zeolites, and aluminates, and salts thereof, and mixtures of these compounds of at least one of the elements Al, Si, P, Sn, Sb, K, Na, Ti, Fe, Zr, Y, V, W, Mo, Ca, Mg, Li, Cr, Mn, Co, Ni, Cu or Zn or a mixture of these elements.

As inorganic, ion-conducting materials it is also possible, however, for at least one partially hydrolyzed compound to be present from the group consisting of oxides, phosphates, phosphites, phosphonates, sulfates, sulfonates, vanadates, stannates, plumbates, chromates, tungstates, molybdates, manganates, titanates, silicates, aluminosilicates, and aluminates or mixtures of these compounds of at least one of the elements Al, K, Na, Ti, Fe, Zr, Y, Va, W, Mo, Ca, Mg, Li, Cr, Mn, Co, Ni, Cu or Zn, or a mixture of these elements. Preferably, the inorganic ion-conducting material present comprises at least one amorphous and/or crystalline compound of at least one of the elements Zr, Si, Ti, Al, Y or vanadium or silicon compounds bearing groups which are in part not hydrolyzable, or mixtures of said elements or compounds, in the composite material. The inorganic, ion-conducting materials may also comprise a compound from the group consisting of zirconium, cerium and titanium phosphates, zirconium cerium and titanium phosphates, phosphonates and sulfoarylphosphonates, and salts thereof, and Al₂O₃, SiO₂, TiO₂, ZrO₂, and P₂O₅.

The membrane of the invention may be flexible. Preferably, the ion-conducting composite material, or the membrane, is flexible down to a minimum radius of 25 mm, preferably 10 mm, with particular preference 5 mm. Where the membranes of the invention are to be used as electrolyte membranes in fuel cells, they should have as low an overall resistance as possible. To achieve this, the proton- and cation-conducting ceramic membranes of the invention comprise a composite material having a high porosity, which may be infiltrated with at least one ionic liquid. Besides the porosity, the overall resistance of the membrane is also dependent on the thickness of the membrane. A membrane of the invention therefore preferably comprises a composite material having a thickness of less than 200 μm, more preferably less than 100 μm, and with very particular preference less than 5 or 20 μm.

The cation- and/or proton-conducting membrane of the invention comprises at least one ionic liquid. Such ionic liquids have already been described. An overview of ionic liquids is given, for example, by Welton (Chem. Rev. 1999, 99, 2071) and by Wasserscheid et al. (Angew. Chem. 2000, 112, 3926-3945). In general, ionic liquids are salts which are present in liquid form at customary service temperatures.

The ionic liquids used in the membranes of the invention preferably comprise at least one salt whose cation is an imidazolium, pyridinium, ammonium or phosphonium ion of the following structures:

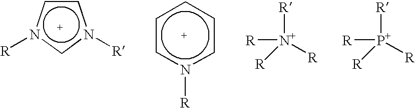

imidazolium pyridinium ammoniumphosphonium ion ion ion ion

where R and R′ may be identical or different alkyl, olefin or aryl groups with the proviso that R and R′ possess different meanings and an anion from the group consisting of BF₄⁻ ions, alkylborate ions, BEt₃Hex ions where Et=ethyl group and Hex=hexyl group, halophosphate ions, PF₆⁻ ions, nitrate ions, sulfonate ions, hydrogen sulfate ions, and chloroaluminate ions.

There are further possibilities for anion/cation combinations which may be suitable as ionic liquids. By combining anions and cations it is possible in particular to prepare salts having specific properties, such as melting point and thermal stability, for example. In preferred variants of the invention, the ionic liquid is itself a Brønsted acid or a salt thereof and thus acts as a proton/cation source, and/or comprises a Brønsted acid and/or salts thereof which act as a proton/cation source.

The membranes of the invention preferably contain from 0.1 to 50% by weight, with particular preference from 1 to 10% by weight, of ionic liquids.

With very particular preference, the ceramic membranes of the invention comprise, as their ionic liquid, the salts indicated in the table below. This table also reports the melting points of the salts. The salts may be prepared as per Welton (Chem. Rev. 1999, 99, 2071) and Wasserscheid et al. (Angew. Chem. 2000, 112, 3926-3945), and the literature cited in these references.

| Salt or ionic liquid | Melting point/° C. |
|---|---|
| [EMIM]CF₃SO₃ | −9 |
| [BMIM]CF₃SO₃ | 16 |
| [Ph₃POc]OTs | 70-71 |
| [Bu₃NMe]OTs | 62 |
| [BMIM]Cl | 65-69 |
| [EMIM]Cl | 87 |
| [MMIM]Cl | 125 |
| [EMIM]NO₂ | 87 |
| [EMIM]NO₃ | 55 |
| [EMIM]AlCl₄ | 38 |
| [EMIM]BF₄ | 7 |
| [EMIM]CF₃CO₂ | −14 |
| [EMIM][CF₃SO₂)₂N] | −3 |

The abbreviations used in the table have the following meanings: EMIM=1-ethyl-3-methythmidazolium ion, BMIM=1-n-butyl-3-methylimidazolium ion, MMIM=1-methyl-3-methylimidazolium ion, Ts=H₃C₆H₄SO₂ (tosyl), Oc=octyl, Et=ethyl, Me=methyl, Bu=n-butyl, CF₃SO₃=triflate anion, and Ph=phenyl.

It is easy to see that, by using alkyl groups having a large number of carbon atoms as radical R and/or R′ in the imidazolium, pyridinium, ammonium or phosphonium ion, the melting point of the salts can be lowered, assuming that the same anions are used.

Depending on the melting point of the salts and/or ionic liquids, the proton- and/or cation-conducting membrane of the invention comprises the ionic liquids at room temperature as liquids or as solidified liquids, i.e., solids. The use of a membrane of the invention in which the ionic liquid is in solid form at room temperature in a fuel cell is possible when, during the operation of the fuel cell, the operating temperature of the fuel cell is higher than the melting point of the ionic liquid. The use of a membrane of the invention in a fuel cell is only possible, however, when the ionic liquid is stable to hydrolysis. Less suitable, therefore, are membranes comprising ionic liquids whose anion is a chloroaluminate ion, since these ionic liquids are highly hydrolysis-labile.

The ionic liquids may further comprise a compound which serves as a proton and/or cation source. These compounds may be present either in suspension or solution in the ionic liquid. As the proton and/or cation source it is possible to use acids or their salts, and also a compound from the group consisting of Al₂O₃, ZrO₂, SiO₂, P₂O₅, and TiO₂, zirconium and titanium phosphates, phosphonates and sulfoarylphosphonates, vanadates, stannates, plumbates, chromates, tungstates, molybdates, manganates, titanates, silicates, aluminosilicates, zeolites and aluminates and acids thereof, carboxylic acids, mineral acids, sulfonic acids, hydroxysilyl acids, phosphonic acids, isopoly acids, heteropoly acids, polyorganylsiloxanes, and trialkoxysilanes, and salts thereof.

The process of the invention for producing an ion-conducting membrane is described by way of example below, without there being any intention to restrict the process of the invention to this production.

The proton- and/or cation-conducting ceramic membranes of the invention which comprise at least one ionic liquid may be produced in various ways. In the production of the membranes of the invention it is possible, firstly, to use composite materials having ion-conducting properties and to treat them with an ionic liquid, which may further comprise an ion-conducting material. Secondly, pervious composite materials which have no ion-conducting properties may be treated, i.e., infiltrated, with a combination of at least one ionic liquid and a material that has ion-conducting properties. By means of either embodiment of the process of the invention it is possible to obtain proton- and/or cation-conducting ceramic membranes of the invention comprising at least one ionic liquid.

In the case of the first embodiment of the process of the invention, the starting material used is a composite material that has ion-conducting properties. The preparation of ion-conducting composite materials of this kind is described, inter alia, in WO 99/62620.

Ion-conducting composite materials of this kind may be obtained by using at least one polymer-bound Brønsted acid or Brønsted base in the preparation of the composite material. The ion-conducting composite material may preferably be obtained by using at least one solution or melt that comprises polyelectrolyte solutions or polymer particles which carry fixed charges. It may be advantageous for the polyelectrolytes or the polymers which carry fixed charges to have a melting point or softening point below 500° C. Preferred for use as polyelectrolytes or polymers which carry fixed charges are sulfonated polytetrafluoroethylene, sulfonated polyvinylidene fluoride, aminolyzed polytetrafluoroethylene, aminolyzed polyvinylidene fluoride, sulfonated polysulfone, aminolyzed polysulfone, sulfonated polyether imide, aminolyzed polyether imide, sulfonated polyether ketone or polyether ether ketone, aminolyzed polyether ketone or polyether ether ketone, or a mixture thereof. The fraction of the polyelectrolytes or of the polymers which carry fixed charges in the melt or solution used is preferably from 0.001% by weight to 50% by weight, with particular preference from 0.01% to 25%. During the preparation and processing of the ion-conducting composite material, the polymer may change chemically and physically, or chemically or physically.

In the preparation of the composite material, the ion-conducting composite material may alternatively be obtained through the use of a sol comprising at least one ion-conducting material or at least one material which has ion-conducting properties following further treatment. To the sol it is preferred to add materials which lead to the formation of inorganic, ion-conducting layers on the inner and/or outer surfaces of the particles present in the composite material.

The sol may be obtained by hydrolyzing at least one metal compound, at least one semimetal compound or at least one mixed metal compound or a phosphorus compound, or a combination of these compounds, with a liquid, a gas and/or a solid. As the liquid, gas and/or solid for the hydrolysis it is preferred to use water, water vapor, ice, alcohol, base or acid, or a combination of these compounds. It may be advantageous to place the compound to be hydrolyzed, prior to the hydrolysis, in alcohol and/or in an acid or base. It is preferred to hydrolyze at least one nitrate, chloride, carbonate, acetylacetonate, acetate or alkoxide of a metal, of a semimetal or of a phosphonic ester. With very particular preference, the nitrate, chloride, acetylacetonate, acetate or alkoxide to be hydrolyzed is a compound of the elements Ti, Zr, V, Mn, W, Mo, Cr, Al, Si, Sn and/or Y.

It may be advantageous if a compound to be hydrolyzed carries nonhydrolyzable groups alongside hydrolyzable groups. As a compound of this kind intended for hydrolysis, it is preferred to use an organyltrialkoxy or diorganyldialkoxy or triorganylalkoxy compound of the element silicon.

If, then, zeolites, β-aluminum oxides, β-aluminosilicates, nanoscale ZrO₂, TiO₂, Al₂O₃ or SiO₂ particles, zirconium phosphates or titanium phosphates are added as particles to the sol, the result is a virtually uniform composite material having virtually uniform ion conduction properties.

To prepare the composite material, at least one water- and/or alcohol-soluble acid or base may be added to the sol. It is preferred to add an acid or base of the elements Na, Mg, K, Ca, V, Y, Ti, Cr, W, Mo, Zr, Mn, Al, Si, P, and S. In another variant, isopoly and heteropoly acids as well may be dissolved in the sol.

The sol used for the inventive production of the membrane or preparation of the ion-conducting composite material may also comprise nonstoichiometric metal oxides, semimetal oxides or nonmetal oxides and/or hydroxides which have been produced by changing the oxidation state of the element in question. The change in oxidation state may occur through reaction with organic compounds or inorganic compounds or through electrochemical reactions. Preferably, the change in oxidation state takes place through reaction with an alcohol, aldehyde, sugar, ether, olefin, peroxide or metal salt. Elements which change oxidation state in this way may be, for example, Cr, Mn, V, Ti, Sn, Fe, Mo, W or Pb.

In this way it is possible to prepare, for example, an ion-conducting pervious composite material composed almost exclusively of inorganic substances. In this case it is necessary to attach fairly great importance to the composition of the sol, since it is necessary to use a mixture of different hydrolyzable components. These individual components must be carefully matched to one another in accordance with their hydrolysis rate. It is also possible to generate the nonstoichiometric metal oxide hydrate sols by means of corresponding redox reactions. The metal oxide hydrates of the elements Cr, Mn, V, Ti, Sn, Fe, Mo, W or Pb may be obtained very effectively by this route. The ion-conducting compound on the inner and outer surfaces then comprises a variety of partially hydrolyzed or nonhydrolyzed oxides, phosphates, phosphides, phosphonates, stannates, plumbates, chromates, sulfates, sulfonates, vanadates, tungstates, molybdates, manganates, titanates, silicates or mixtures thereof of the elements Al, K, Na, Ti, Fe, Zr, Y, Va, W, Mo, Ca, Mg, Li, Cr, Mn, Co, Ni, Cu, and Zn, or mixtures of these elements.

In a further embodiment of the membranes, existing pervious ion-conducting or non-ion-conducting composite materials may be treated with ion-conducting materials or with materials which have ion-conducting properties following further treatment. Composite materials of this kind may be commercially customary pervious materials or composite materials, or else composite materials as described, for example, in PCT/EP98/05939. It is, however, also possible to use composite materials obtained by the process described above.

Ion-conducting pervious composite materials may be obtained by treating a composite material having a pore size of from 0.001 to 5 μm, with or without ion-conducting properties, with at least one ion-conducting material or with at least one material which has ion-conducting properties following further treatment.

The treatment of the composite material with at least one ion-conducting material or with at least one material which has ion-conducting properties following further treatment may take place by impregnating, dipping, brushing, rolling, knifecoating, spraying or other coating techniques. Following the treatment with at least one ion-conducting material or with at least one material which has ion-conducting properties following further treatment, the composite material is preferably subjected to a thermal treatment. With particular preference, the thermal treatment takes place at a temperature of from 100 to 700° C.

The ion-conducting material or the material which has ion-conducting properties following further treatment is preferably applied in the form of a solution having a solvent fraction of 1-99.8% to the composite material.

As the material for preparing the ion-conducting composite material it is possible in accordance with the invention to use polyorganylsiloxanes comprising at least one ionic constituent. The polyorganylsiloxanes may comprise, inter alia, polyalkylsiloxanes and/or polyarylsiloxanes and/or further constituents.

It may be advantageous to use at least one Brønsted acid or Brønsted base as material for preparing the ion-conducting composite material. It may likewise be advantageous for the material to prepare the ion-conducting composite material to comprise at least one suspension or solution of a trialkoxysilane containing acidic and/or basic groups. At least one of the acidic or basic groups is preferably a quaternary ammonium, phosphonium, alkylsulfonic acid, arylsulfonic acid, carboxylic acid or phosphonic acid group.

Accordingly, by means of the process of the invention, it is possible to render, for example, an existing pervious composite material ionic, subsequently, by treatment with a silane or siloxane. For this purpose, a 1-20% strength solution of this silane in a water-containing solution is prepared, and the composite material is immersed therein. The solvents used may be aromatic and aliphatic alcohols, aromatic and aliphatic hydrocarbons, and other common solvents or mixtures. It is advantageous to use ethanol, octanol, toluene, hexane, cyclohexane, and octane. After the adhering liquid has dripped off, the impregnated composite material is dried at approximately 150° C. and may then be used, either directly or following multiple subsequent coating and drying at 150° C., as an ion-conducting pervious composite material. Silanes and siloxanes suitable for this purpose include both these which carry cationic groups and these which carry anionic groups.

It may further be advantageous if the solution or suspension for treating the composite material comprises not only a trialkoxysilane but also acidic or basic compounds and water. The acidic or basic compounds preferably comprise at least one Brønsted or Lewis acid or base known to the skilled worker. In one specific embodiment the sol comprises silylsulfonic or silylphosphonic acids, with particular preference hydroxysilylsulfonic acids, and with very particular preference trihydroxysilylpropylsulfonic acid, or salts thereof.

In accordance with the invention, however, the composite material may also be treated with solutions, suspensions or sols comprising at least one ion-conducting material. This treatment may be performed once or repeated a number of times. This embodiment of the process of the invention produces coats of one or more identical or different, partially hydrolyzed or nonhydrolyzed oxides, phosphates, phosphides, phosphonates, sulfates, sulfonates, vanadates, tungstates, molybdates, manganates, titanates, silicates or mixtures thereof of the elements Al, Si, P, K, Na, Ti, Fe, Zr, Y, Va, W, Mo, Ca, Mg, Li, Cr, Mn, Co, Ni, Cu, and Zn, or mixtures of these elements.

The sols or suspensions may, however, also comprise one or more compounds from the group consisting of nanoscale Al₂O₃, ZrO₂, TiO₂ and SiO₂ powders, zeolites, isopolyacids and heteropolyacids, and zirconium or titanium sulfoarylphosphonates.

In another embodiment the sol which the ion-conducting material may comprise comprises further hydrolyzed metal, semimetal or mixed metal compounds. These compounds have already been described in detail in connection with the sols for preparing the composite material.

Ion-conducting composite materials thus prepared, and membranes thus produced, may be flexible. In particular, such ion-conducting composite materials and, respectively, membranes may be designed to be flexible down to a smallest radius of 25 mm.

In the membranes of the invention it is, however, possible to use not only ion-conducting composite materials which have been prepared in this way, but also ion-conducting composite materials prepared by other processes.

Moreover, the non-ion-conducting composite materials which may be used in accordance with the invention preferably have a porosity of 5-50%, whereas the ion-conducting composite materials have a porosity of 0.5-10%.

In accordance with the invention, an ion-conducting composite material of this kind is infiltrated with an ionic liquid or with a solution containing an ionic liquid.

Suitable ionic liquids are all salts which are liquid at room temperature or at the temperature at which the membrane is to be used.

The salts used as ionic liquids are preferably those having a melting temperature of below 100° C., more preferably below 50° C., with very particular preference below 20° C., and with very particular preference below 0° C. In a further variant the ionic liquid is diluted with a solvent (alcohols, ketones, esters, water) or, if in solid form, is dissolved in the solvent, the membrane is infiltrated with this solution, and the membrane is dried, i.e., freed from the solvent.

In the text below, infiltration of the composite material is equated with infiltration of the membrane.

The infiltration of the ionic liquid into the composite material may take place at room temperature or at elevated temperature. Preferably, infiltration is conducted at a temperature at which the ionic liquid is in liquid form.

Infiltration may take place by spraying, knifecoating, rolling or brushing of the ionic liquid or its solution in a customary organic solvent such as methanol, for example, onto the composite material or by dipping (preferably under vacuum) the ion-conducting composite material into an ionic-liquid. The ionic liquids are infiltrated into the composite material by the capillary forces. Following coating, it may be necessary if appropriate to remove excess liquid by spinning, wiping or blowing and to remove any additional solvents used by drying, for example.

In the second embodiment of the process of the invention, the starting material used is a composite material which does not have ion-conducting properties. The production of such composite materials is described, inter alia, in WO 99/15262.

In this process for producing the composite material, at least one suspension comprising at least one inorganic component comprising at least one compound of at least one metal, semimetal or mixed metal with at least one of the elements from main groups 3 to 7 is applied into and onto at least one perforate and pervious support, and the suspension is solidified on and in the support material by heating it at least once.

The suspension may be applied onto and into the support by printing, pressing, injecting, rolling, knifecoating, brushing, dipping, spraying or pouring.

The perforate and pervious support onto and into which at least one suspension is applied may comprise at least one material selected from glasses, ceramics, minerals, plastics, amorphous substances, natural products, composites and composite materials or from at least one combination of said materials. Pervious supports used may also comprise those which have been made pervious by treatment with laser beams or ion beams. The supports used preferably comprise wovens or nonwovens made from fibers of the materials indicated above, such as woven glass mats or woven mineral fiber mats, for example.

The suspension used, which may comprise at least one inorganic component and at least one metal oxide sol, at least one semimetal oxide sol or at least one mixed metal oxide sol, or a mixture of said sols, may be prepared by suspending at least one inorganic component into at least one of said sols.

The sols are obtained by hydrolyzing at least one compound, having at least one metal compound, at least one semimetal compound or at least one mixed metal compound, with at least one liquid, solid or gas, in which context it may be advantageous if the liquid used comprises, for example, water, alcohol or an acid, the solid used comprises ice, or the gas used comprises water vapor, or else if at least one combination of said liquids, solids or gases is used. Similarly, it may be advantageous if the compound to be hydrolyzed is placed, prior to hydrolysis, in alcohol or an acid or a combination of these liquids. The compound to be hydrolyzed preferably comprises at least one metal nitrate, metal chloride, metal carbonate, metal alkoxide compound, or at least one semimetal alkoxide compound, with particular preference at least one metal alkoxide compound, metal nitrate, metal chloride, metal carbonate or semimetal alkoxide compound selected from the compounds of the elements Ti, Zr, Al, Si, Sn, Ce, and Y, such as titanium alkoxides, such as titanium isopropoxide, silicon alkoxides, zirconium alkoxides or a metal nitrate, such as zirconium nitrate, for example.

It may be advantageous if the compounds to be hydrolyzed are hydrolyzed using at least half the molar ratio of water, water vapor or ice, based on the hydrolyzable group of the hydrolyzable compound.

For peptizing, the hydrolyzed compound may be treated with at least one organic or inorganic acid, preferably with an organic or inorganic acid in a concentration of from 10 to 60%, with particular preference with a mineral acid, selected from sulfuric acid, hydrochloric acid, perchloric acid, phosphoric acid, and nitric acid, or a mixture of said acids.

It is possible to use not only sols prepared as described above but also commercially customary sols, such as titanium nitrate sol, zirconium nitrate sol or silica sol, for example. It is, however, also possible to prepare and use sols in accordance with the prior art.

It may be advantageous if at least one inorganic component having a particle size of from 0.5 nm to 10 μm is suspended in at least one of said sols. Preferably, the inorganic component suspended comprises at least one compound selected from metal compounds, semimetal compounds, mixed metal compounds, and mixed metal compounds, with at least one of the elements from main groups 3 to 7, or at least one mixture of said compounds. With particular preference, the component suspended comprises at least one inorganic component comprising at least one compound of the oxides of the transition group elements or the elements from main groups 3 to 5, preferably oxides selected from the oxides of the elements Sc, Y, Ti, Zr, Nb, Ce, V, Cr, Mo, W, Mn, Fe, Co, B, Al, In, TI, Si, Ge, Sn, Pb, and Bi, such as Y₂O₃, ZrO₂, Fe₂O₃, Fe₃O₄, SiO₂, and Al₂O₃, for example. The inorganic component may also comprise aluminosilicates, aluminum phosphates, zeolites or partially exchanged zeolites, such as ZSM-5, Na-ZSM-5 or Fe-ZSM-5, for example, or amorphous microporous mixed oxides, which may contain up to 20% of nonhydrolyzable organic compounds, such as vanadium oxide-silicon oxide glass or aluminum oxide-silicon oxide-methylsilicon sesquioxide glasses, for example.

The mass fraction of the suspended component is preferably from 0.1 to 500 times that of the hydrolyzed compound employed.

Through the appropriate choice of the particle size of the suspended compounds as a function of the size of the pores, holes or interstices of the perforate pervious support, but also through the layer thickness of the composite material of the invention and through the proportional sol/solvent/metal oxide ratio, it is possible to optimize the freedom from cracks in the composite material of the invention.

When using a woven mesh having a mesh size of, for example, 100 μm it is possible to increase the freedom from cracks by using, preferably, suspensions comprising a suspended compound having a particle size of at least 0.7 μm. The composite material of the invention may preferably have a thickness of from 5 to 1,000 μm, with particular preference from 20 to 100 μm. The suspension comprising the sol and the compounds to be suspended preferably has a ratio of sol to compounds to be suspended of from 0.1:100 to 100:0.1, more preferably from 0.1:10 to 10:0.1, parts by weight.

The suspension present on or in, or else on and in, the support may be solidified by heating this system at from 50 to 1,000° C. In one particular embodiment of the process of the invention, said system is subjected to a temperature of from 50 to 100° C. for from 10 minutes to 5 hours. In another particular embodiment of the process of the invention, said system is subjected to a temperature of from 100 to 800° C. for from one second to 10 minutes.

The inventive heating of the system may take place by means of heated air, hot air, infrared radiation, microwave radiation, or electrically generated heat.

A non-ion-conducting composite material of this kind may be subsequently infiltrated with a solution or suspension comprising at least one cation/proton-conducting material and at least one ionic liquid. These materials may be those already mentioned in connection with the first variant of the process.

As cation/proton-conducting materials it is possible, for example, to use polyorganylsiloxanes containing at least one ionic constituent. The polyorganylsiloxanes may comprise, inter alia, polyalkylsiloxanes and/or polyarylsiloxanes and/or further constituents.

It may also be advantageous if the cation/proton-conducting materials used comprise Brønsted or Lewis acids or bases. It may likewise be advantageous if the material used to produce the membranes of the invention comprises at least one solution or suspension of a trialkoxysilane containing acidic and/or basic groups. Preferably, at least one of the acidic or basic groups is a quaternary ammonium, phosphonium, silylsulfonic or silylphosphonic acid, carboxylic acid or phosphonic acid group.

In general it is possible to use cation/proton-conducting materials which readily give out protons or cations, such as carboxylic acids of low vapor pressure, mineral acids, sulfonic acids, phosphonic acids, nanoscale powders, such as Al₂O₃, TiO₂, SiO₂, ZrO₂, zirconium or titanium phosphates, phosphonates, and sulfoarylphosphonates, isopoly acids and heteropoly acids, zeolites, and β-aluminum oxides. In the case of the acid it is also possible to use the corresponding salts.

As cation/proton-conducting materials, the solution or suspension may also contain one or more identical or different, partially hydrolyzed or nonhydrolyzed oxides, phosphates, phosphides, phosphonates, sulfates, sulfonates, vanadates, tungstates, molybdates, manganates, titanates, silicates or mixtures thereof of the elements Al, K, Na, Ti, Fe, Zr, Y, Va, W, Mo, Ca, Mg, Li, Cr, Mn, Co, Ni, Cu, and Zn, or mixtures of these elements.

As cation/proton-conducting materials, the solution or suspension may also comprise polyelectrolytes or polymer particles which carry fixed charges. It may be advantageous for the polyelectrolytes or the polymers which carry fixed charges to have a melting point or softening point below 500° C. Preferred for use as polyelectrolytes or polymers which carry fixed charges are sulfonated polytetrafluoroethylene, sulfonated polyvinylidene fluoride, aminolyzed polytetrafluoroethylene, aminolyzed polyvinylidene fluoride, sulfonated polysulfone, aminolyzed polysulfone, sulfonated polyether imide, aminolyzed polyether imide, sulfonated polyether ketone or polyether ether ketone, aminolyzed polyether ketone or polyether ether ketone, or a mixture thereof. The fraction of the polyelectrolytes or of the polymers which carry fixed charges in the suspension or solution used is preferably from 0.001% by weight to 50% by weight, with particular preference from 0.01% to 25%.

Preferably, the suspensions or solutions used have a fraction of ionic liquid of from 5 to 90% by volume, preferably from 10 to 30% by volume, and a fraction of proton/cation-conducting material of from 10 to 95% by volume, preferably from 70 to 90% by volume.

Using the suspensions or solutions, the non-ion-conducting composite materials may be infiltrated as described above.

The cation- and/or proton-conducting, ceramic membranes of the invention may be used with particular advantage in fuel cells. A condition for the use of such a membrane as an electrolyte membrane in a fuel cell is that the membrane of the invention must comprise an ionic liquid which is stable in the presence of the ion-conducting materials, which is stable and liquid at the operating temperature of the fuel cell, and which is resistant to hydrolysis, since water is formed in the fuel cell during operation.

In another aspect, the present invention therefore provides a fuel cell which comprises at least one cation- and/or proton-conducting, ceramic membrane comprising an ionic liquid. The use of a membrane of the invention in a fuel cell, and with particular preference in a reformate fuel cell or direct methanol fuel cell, is appropriate in particular owing to its better thermal stability in comparison to polymer membranes. Presently, the working range of fuel cells based on proton-conductive membranes is limited, by the use of Nafion® as membrane, to a temperature of typically 80-90, at most 120-130° C. Higher temperatures lead to a severe decrease in the ionic conductivity of the Nafion. In the aforementioned type of fuel cell, a higher operating temperature results in a distinct improvement in service life, since the problem of catalyst poisoning by carbon monoxide is suppressed. When the membrane of the invention is used, the ionic liquids it comprises ensure that even at temperatures of a maximum of 300° C., preferably a maximum of 200° C., and even in a water-free atmosphere, the high conductivity is retained and thus, along with it, the high power density. The membrane of the invention is therefore especially suitable as an electrolyte membrane in a direct methanol fuel cell.

Besides its use in a fuel cell, the membrane of the invention is suitable for use in electrodialysis, electrolysis, and catalysis.

The cation/proton-conducting membrane of the invention, the process for producing it, and its use are described with reference to the following examples, without being restricted thereto.

### EXAMPLE 1

### Non-Ion-Conducting Composite Material

120 g of zirconium tetraisopropoxide are vigorously stirred with 140 g of deionized ice until the resulting precipitate is very finely divided. Following the addition of 100 g of 25% strength hydrochloric acid, stirring is continued until the phase becomes clear, and 280 g of α-aluminum oxide of the type CT300SG from Alcoa, Ludwigshafen, are added and the mixture is stirred for several days until the aggregates have been broken down.

This suspension is subsequently applied in a thin film to a woven glass mat (11-tex yarn with 28 warp and 32 weft threads) and solidified at 550° C. within 5 seconds.

### EXAMPLE 2

### Production of a Proton-Conducting Membrane

10 ml of anhydrous trihydroxysilylpropylsulfonic acid, 30 ml of ethanol and 5 ml of water are mixed by stirring. 40 ml of TEOS (tetraethyl orthosilicate) are slowly added dropwise to this mixture, with stirring. In order to achieve a certain condensation, this sol is stirred in a closed vessel for 24 h. The composite material from Example 1 is immersed in this sol for 15 minutes. Subsequently, the sol in the impregnated membrane is gelled in air for 60 minutes and dried.

The membrane filled with the gel is dried at a temperature of 200° C. for 60 minutes, so that the gel is solidified and rendered insoluble in water. In this way an impermeable membrane is obtained which has a proton conductivity of approximately 2·10⁻³ S/cm at room temperature and normal ambient air.

### EXAMPLE 3

### Production of a Proton-Conducting Membrane

25 g of tungstophosphoric acid are additionally dissolved in 50 ml of the sol from Example 2. The composite material from Example 1 is immersed in this sol for 15 minutes. The subsequent procedure is as in Example 2.

### EXAMPLE 4

### Production of a Proton-Conducting Membrane

100 ml of titanium isopropoxide are added dropwise to 1,200 ml of water with vigorous stirring. The resulting precipitate is aged for 1 h, after which 8.5 ml of concentrated HNO₃ are added and the precipitate is peptized in the heat of boiling for 24 h. 50 g of tungstophosphoric acid are dissolved in 25 ml of this sol and then the composite material from Example 1 is dipped in the sol for 15 minutes. The membrane is then dried, solidified by a temperature treatment at 600° C., and converted into the proton-conductive form.

### EXAMPLE 5

### Production of a Proton-Conducting Membrane

Sodium trihydroxysilylmethylphosphonate dissolved in a little water is diluted with ethanol. An equal amount of TEOS is added to this solution, followed by brief stirring. The composite material from Example 1 is immersed in this sol for 15 minutes. The membrane is then dried and solidified at 250° C. to give the proton-conductive membrane.

### EXAMPLE 6

### Production of a Proton-Conducting Membrane

20 g of aluminum alkoxide and 17 g of vanadium alkoxide are hydrolyzed with 20 g of water and the resulting precipitate is peptized using 120 g of nitric acid (25% strength). This solution is stirred until it clarifies, and following the addition of 40 g of titanium dioxide from Degussa (P25) stirring is continued until all the agglomerates have broken down. The suspension is adjusted to a pH of about 6 and then applied by knifecoating to a composite material produced in accordance with Example 1. Following thermal treatment at 600° C., the ion-conducting membrane is obtained.

### EXAMPLE 7

### Production of a Proton-Conducting Membrane

10 g of methyltriethoxysilane, 30 g of tetraethyl orthosilicate and 10 g of aluminum trichloride are hydrolyzed with 50 g of water in 100 g of ethanol. Then 190 g of zeolite USY (CBV 600 from Zeolyst) are added. Stirring is continued until all the agglomerates have broken down, and then the suspension is coated onto a composite material produced in accordance with Example 1, solidified by a temperature treatment at 700° C., and converted into the ion-conducting membrane.

### EXAMPLE 8

### Infiltration of a Proton-Conducting Membrane with the Ionic Liquid

An ion-conducting composite material as per Examples 2-7 may be sprayed with [EMIM]CF₃SO₃ as an ionic liquid. Spraying may continue, from one side of the composite material, until the opposite side of the composite material is likewise wetted by the ionic liquid which has passed through the composite material. This makes it possible to ensure that the air present in the porous ion-conducting composite material has been displaced by the ionically conducting liquid. After excess ionic liquid has been stripped off, this membrane may also be dried in air. As a result of capillary forces, the ionic liquid is retained in the membrane of the invention. Since ionic liquids have no measurable vapor pressure, a reduction in the amount of ionic liquid in the membrane is unlikely even following prolonged storage of the membranes produced in accordance with the invention.

### EXAMPLE 9

### Infiltration of a Proton-Conducting Membrane with the Ionic Liquid

Instead of the [EMIM]CF₃SO₃ from Example 8, an ionic liquid selected from the table listed in the text is used. The ion-conducting composite material from one of Examples 2-7 is immersed in the ionic liquid for 30 minutes. After the excess ionic liquid has dripped off, the membrane may be installed in a fuel cell.

### EXAMPLE 10

### Production of an Ion-Conducting Membrane

The non-ion-conducting composite material from Example 1 is immersed for 30 minutes in [EMIM]CF₃SO₃ containing a total of 50% by weight trihydroxysilylpropylsulfonic acid, tetraethyl orthosilicate, and a small amount of water. After the silicon compounds have been gelled and the material subjected to a heat treatment at up to 180° C., the proton-conducting membrane is obtained.

What is claimed is:

1. A cation/proton-conducting membrane comprising a composite material based on at least one perforate and pervious support, wherein the voids of the membrane comprise an ionic liquid.

2. The membrane as claimed in claim 1 which is ceramic or grasslike.

3. The membrane as claimed in claim 1 or 2, wherein on and inside the support of the composite material there is at least one inorganic component substantially comprising at least one compound of a metal, semimetal or mixed metal with at least one element from main groups 3 to 7.

4. The membrane as claimed in any of claims 1 to 3, which has proton/cation-conducting properties at a temperature of from −40° C. to 350° C.

5. The membrane as claimed in claim 4, which has proton/cation-conducting properties at a temperature of from −10° C. to 200° C.

6. The membrane as claimed in at least one of claims 1 to 5, wherein the ionic liquid comprises at least one salt comprising a cation selected from the group consisting of imidazolium ion, pyridinium ion, ammonium ion and phosphonium ion having the following structures: 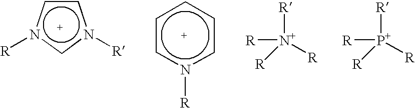
where R and R′ may be identical or different alkyl, olefin or aryl groups with the proviso that R and R′ possess different meanings and an anion from the group consisting of BF₄⁻ ions, alkylborate ions, BEt₃Hex ions where Et=ethyl group and Hex=hexyl group, halophosphate ions, PF₆⁻ ions, nitrate ions, sulfonate ions, hydrogen sulfate ions, and chloroaluminate ions.

7. The membrane as claimed in one of claims 1 to 6, which has a thickness of less than 200 μm.

8. The membrane as claimed in at least one of claims 1 to 7, which is flexible.

9. The membrane as claimed in at least one of claims 1 to 8, which is flexible down to a minimum radius of 25 mm.

10. The membrane as claimed in at least one of claims 1 to 9, comprising a composite material comprising a support comprising at least one material selected from glasses, plastics, natural substances, ceramics, and mineral substances.

11. The membrane as claimed in claim 10, wherein the support comprises a woven or nonwoven.

12. The membrane as claimed in at least one of claims 1 to 11, wherein the composite material comprises or consists of at least one organic and/or inorganic material having ion-conducting properties, as an admixture or on the surface.

13. The membrane as claimed in one of claims 1 to 12, wherein at least one organic and/or inorganic material having ion-conducting properties is present in the interparticulate volumes or pores of the composite material.

14. The membrane as claimed in at least one of claims 12 and 13, wherein the material having ion-conducting properties comprises sulfonic acids, phosphonic acids, carboxylic acids or salts thereof, individually or as a mixture.

15. The membrane as claimed in claim 14, wherein the sulfonic or phosphonic acids are silylsulfonic acids or silylphosphonic acids.

16. The membrane as claimed in at least one of claims 12 to 15, wherein at least one polymer is present in the composite material as organic, ion-conducting material.

17. The membrane as claimed in claim 16, wherein the polymer is a sulfonated polytetrafluoroethylene, sulfonated polyvinylidene fluoride, aminolyzed polytetrafluoroethylene, aminolyzed polyvinylidene fluoride, sulfonated polysulfone, aminolyzed polysulfone, sulfonated polyether imide, aminolyzed polyether imide, sulfonated polyether ketone or polyether ether ketone, aminolyzed polyether ketone or polyether ether ketone, or a mixture thereof.

18. The membrane as claimed in at least one of claims 12 to 17, wherein the inorganic, ion-conducting materials comprise at least one compound from the group consisting of oxides, oxyacids, phosphates, phosphides, phosphonates, sulfates, sulfonates, hydroxysilyl acids, sulfoarylphosphonates, vanadates, stannates, plumbates, chromates, tungstates, molybdates, manganates, titanates, silicates, aluminosilicates, zeolites, and aluminates, and salts thereof, and mixtures of these compounds of at least one of the elements Al, Si, P, Sn, Sb, K, Na, Ti, Fe, Zr, Y, V, W, Mo, Ca, Mg, Li, Cr, Mn, Co, Ni, Cu, and Zn, and a mixture of these elements.

19. The membrane as claimed in at least one of claims 12 to 18, wherein the inorganic, ion-conducting materials comprise at least one compound from the group consisting of zirconium, cerium and titanium phosphates, phosphonates, and sulfoarylphosphonates, and salts thereof, and Al₂O₃, SiO₂, TiO₂, ZrO₂, and P₂O₅.

20. The membrane as claimed in at least one of claims 1 to 19, wherein the ionic liquid is a Brønsted acid or salt thereof or comprises as proton/cation source a Brønsted acid or salt thereof.

21. The membrane as claimed in claim 20, wherein the cation/proton source is suspended or dissolved in the ionic liquid and comprises at least one compound from the group consisting of Al₂O₃, ZrO₂, SiO₂, P₂O₅, and TiO₂, zirconium and titanium phosphates, phosphonates, and sulfoarylphosphonates, vanadates, stannates, plumbates, chromates, tungstates, molybdates, manganates, titanates, silicates, aluminosilicates, zeolites, and aluminates, and acids thereof, carboxylic acids, mineral acids, sulfonic acids, hydroxysilyl acids, phosphonic acids, isopoly acids, heteropoly acids, polyorganylsiloxanes, and trialkoxysilanes, and salts thereof.

22. A process for producing a proton/cation-conducting membrane comprising a composite material based on at least one perforate and pervious support, which comprises infiltrating a membrane with an ionic liquid.

23. The process as claimed in claim 22, wherein the membrane is ceramic or glasslike.

24. The process as claimed in claim 22 or 23, wherein on and inside the support of the composite material there is at least one inorganic component substantially comprising at least one compound of a metal, semimetal or mixed metal with at least one element from main groups 3 to 7.

25. The process as claimed in one of claims 22 to 24, wherein the membrane has proton/cation-conducting properties at a temperature of from −40° C. to 350° C.

26. The process as claimed in claim 25, wherein the membrane has proton/cation-conducting properties at a temperature of from −10° C. to 200° C.

27. The process as claimed in at least one of claims 22 to 26, wherein the ionic liquid comprises at least one salt comprising a cation selected from the group consisting of imidazolium ion, pyridinium ion, ammonium ion and phosphonium ion having the following structures: 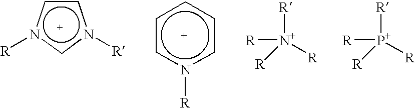
where R and R′ may be identical or different alkyl, olefin or aryl groups with the proviso that R and R′ possess different meanings and an anion from the group consisting of BF₄⁻ ions, alkylborate ions, BEt₃Hex ions where Et=ethyl group and Hex=hexyl group, halophosphate ions, PF₆⁻ ions, nitrate ions, sulfonate ions, hydrogen sulfate ions, and chloroaluminate ions.

28. The process as claimed in one of claims 22 to 27, wherein the membrane has a thickness of less than 200 μm.

29. The process as claimed in at least one of claims 22 to 28, wherein the membrane is flexible.

30. The process as claimed in at least one of claims 22 to 29, wherein the membrane is flexible down to a minimum radius of 25 mm.

31. The process as claimed in at least one of claims 22 to 30, wherein the membrane comprises a composite material comprising a support comprising at least one material selected from glasses, plastics, natural substances, ceramics, and mineral substances.

32. The process as claimed in claim 31, wherein the support comprises a fiber woven or nonwoven.

33. The process as claimed in at least one of claims 22 to 32, wherein the composite material comprises or consists of at least one organic and/or inorganic material having ion-conducting properties, as an admixture or on the surface.

34. The process as claimed in one of claims 22 to 33, wherein at least one organic and/or inorganic material having ion-conducting properties is present in the interparticulate volumes or pores of the composite material.

35. The process as claimed in one of claims 33 and 34, wherein the material having ion-conducting properties comprises sulfonic acids, phosphonic acids, carboxylic acids or salts thereof, individually or as a mixture.

36. The process as claimed in claim 35, wherein the sulfonic or phosphonic acids are silylsulfonic acids or silylphosphonic acids.

37. The process as claimed in at least one of claims 33 to 36, wherein at least one polymer is present in the composite material as organic, ion-conducting material.

38. The process as claimed in claim 37, wherein the polymer is a sulfonated polytetrafluoroethylene, sulfonated polyvinylidene fluoride, aminolyzed polytetrafluoroethylene, aminolyzed polyvinylidene fluoride, sulfonated polysulfone, aminolyzed polysulfone, sulfonated polyether imide, aminolyzed polyether imide, sulfonated polyether ketone or polyether ether ketone, aminolyzed polyether ketone or polyether ether ketone, or a mixture thereof.

39. The process as claimed in at least one of claims 33 to 38, wherein the inorganic, ion-conducting materials comprise at least one compound from the group consisting of oxides, oxyacids, phosphates, phosphides, phosphonates, sulfates, sulfonates, hydroxysilyl acids, sulfoarylphosphonates, vanadates, stannates, plumbates, chromates, tungstates, molybdates, manganates, titanates, silicates, aluminosilicates, zeolites, and aluminates, and salts thereof, and mixtures of these compounds of at least one of the elements Al, Si, P, Sn, Sb, K, Na, Ti, Fe, Zr, Y, V, W, Mo, Ca, Mg, Li, Cr, Mn, Co, Ni, Cu, and Zn, and a mixture of these elements.

40. The process as claimed in at least one of claims 33 to 39, wherein the inorganic, ion-conducting materials comprise at least one compound from the group consisting of zirconium, cerium and titanium phosphates, phosphonates, and sulfoarylphosphonates, and salts thereof, and Al₂O₃, SiO₂, TiO₂, ZrO₂, and P₂O₅.

41. The process as claimed in at least one of claims 22 to 40, wherein the ionic liquid is a Brønsted acid or salt thereof or comprises as proton/cation source a Brønsted acid or salt thereof.

42. The process as claimed in claim 41, wherein the cation/proton source is suspended or dissolved in the ionic liquid and comprises at least one compound from the group consisting of Al₂O₃, ZrO₂, SiO₂, P₂O₅, and TiO₂, zirconium and titanium phosphates, phosphonates, and sulfoarylphosphonates, vanadates, stannates, plumbates, chromates, tungstates, molybdates, manganates, titanates, silicates, aluminosilicates, zeolites, and aluminates, and acids thereof, carboxylic acids, mineral acids, sulfonic acids, hydroxysilyl acids, phosphonic acids, isopoly acids, heteropoly acids, polyorganylsiloxanes, and trialkoxysilanes, and salts thereof.

43. The use of the membrane as claimed in at least one of claims 1 to 21 as an electrolyte membrane in a fuel cell.

44. The use of the membrane as claimed in at least one of claims 1 to 21 as a catalyst for acid- or base-catalyzed reactions.

45. The use of the membrane as claimed in at least one of claims 1 to 21 as a membrane in electrodialysis, in membrane electrolysis, or in electrolysis.

46. A fuel cell comprising at least one electrolyte membrane, wherein the fuel cell comprises as electrolyte membrane a cation/proton-conducting ceramic membrane comprising at least one ionic liquid, as claimed in at least one of claims 1 to 21.
